(19) United States
(12) Patent Application Publication
(10) Pub. No.: US 2004/0128523 A1
(43) Pub. Date: Jul. 1, 2004

(54) Information security microcomputer having an information securtiy function and authenticating an external device

(75) Inventor: Shuzo Fujioka, Hyogo (JP)

Correspondence Address: BURNS, DOANE, SWECKER & MATHIS, L.LP., P.O. Box 1404, Alexandria, VA, 22314-1404, US

(73) Assignees: RENESAS TECHNOLOGY CORP.; RENESAS LSI DESIGN CORPORATION

(21) Appl. No.: 10/615,792

(22) Filed: Jul. 10, 2003

(30) Foreign Application Priority Data
Dec. 27, 2002 (JP) 2002-380316(P)

(51) Int. Cl. H04L 9/32; G06F 11/30

(52) U.S. Cl. 713/189

(57) ABSTRACT

An information security microcomputer includes an encryption circuit encrypting and decrypting information, an authentication program authenticating an ICE main body, and a CPU performing entire control of the information security microcomputer. CPU stops at least a part of a function of the information security microcomputer when the ICE main body cannot be authenticated. Therefore, an unauthorized person cannot use the information security microcomputer as an ICE microcomputer so that security can be improved.

### BACKGROUND OF THE INVENTION

1. Field of the Invention

The present invention relates to a microcomputer, which has an information security function and will be simply referred to as an “information security microcomputer” hereinafter, and particularly, to an information security microcomputer used for in-circuit emulator (which will be simply referred to as an “ICE” hereinafter), a program developing device for the information security microcomputer and a program developing system including them.

2. Description of the Background Art

In recent years, information security has been widely used for determining a validity of a user and preventing leakage of information, and microcomputers having an information security function have been developed. In such information security microcomputers, debugging is performed with the ICE during program development, similarly to general microcomputers.

An ICE main body has a host interface used for connection to a personal computer (which may be simply referred to as a “PC”) and an ICE interface used for connection to an ICE microcomputer (i.e., microcomputer for ICE), and further has a function of performing entire control of the ICE.

The ICE main body operates in accordance with instructions, which are issued from the personal computer, to achieve functions of executing programs for the ICE microcomputer, dumping contents of a memory mounted on a target board, executing steps for executing programs on an instruction-by-instruction basis, and breaking (i.e., stopping the program at an intended address). A technology relating to the above is disclosed in Japanese Patent Laying-Open No. 2000-347942.

An information processing device disclosed in Japanese Patent Laying-Open No. 2000-347942 protects information stored in a ROM (Read Only Memory) from unauthorized access by an external debug tool, and operates to compare a code registered in advance with a password, which is externally provided. When these match with each other, the function of the on-chip debug circuit is enabled.

The foregoing ICE is originally aimed at use for program development of microcomputers, but suffers from a problem that it may be abused to perform reverse engineering, analysis of programs and tampering of information.

Further, the conventional ICE operates even when it is connected to an external device, which is not authorized to connect to the ICE. This results in a problem that a malicious person can utilize the ICE to analyze a system carrying an information security microcomputer, and to counterfeit an information security microcomputer.

The ICE microcomputer has the same function as the information security microcomputer, which is a target of the program development, and an ICE interface allowing control by the ICE main body. Therefore, the following problem arises. By mounting the ICE microcomputer instead of the information security microcomputer, it may be utilized for counterfeiting the system or for analyzing the information security microcomputer.

The personal computer connected to the ICE has stored security information such as a program to be executed by the information security microcomputer. Therefore, such a problem further arises that the program may be stolen if anyone can utilize the personal computer without authorization.

In a system having the personal computer and the ICE connected to a network, a program to be debugged by the ICE is downloaded from the personal computer to the ICE. Therefore, such a problem further arises that the information may be intercepted, and the program may be stolen.

Further, in the foregoing information processing device disclosed in Japanese Patent Laying-Open No. 2000-347942, the code registered in advance is compared with the externally provided password. When these match with each other, the function of the on-chip debug circuit is enabled to prevent the unauthorized access to the ROM. However, even an external device, of which connection is not authorized, can read the contents of the ROM when the password is entered. Therefore, the security cannot be enhanced.

### SUMMARY OF THE INVENTION

An object of the invention is to provide an information security microcomputer, which cannot be used as an ICE microcomputer by an unauthorized person.

According to an aspect of the invention, an information security microcomputer having an information security function includes an encrypting unit encrypting and decrypting information, an authenticating unit authenticating an external device, and a processor performing entire control of the information security microcomputer, and stopping at least a part of a function of the information security microcomputer when the authenticating unit cannot perform the authentication.

When the authenticating unit cannot authenticate the external device, the processor stops at least a part of the function of the information security microcomputer. Therefore, an unauthorized person cannot use the information security microcomputer as an ICE microcomputer so that the security can be improved.

According to another aspect of the invention, a program developing device includes an information security microcomputer having an information security function, and a main body controlling the information security microcomputer to assist program development. The main body includes a control unit performing authentication with respect to the information security microcomputer, and issuing a command to control the information security microcomputer. The information security microcomputer includes an authenticating unit performing authentication with respect to the main body, and a processor performing entire control of the information security microcomputer, and stopping at least a part of a function of the information security microcomputer.

The authentication is attempted between the main body and the information security microcomputer, and at least a part of the function of the information security microcomputer is stopped when the authentication is impossible. Therefore, an unauthorized main body cannot use the information security microcomputer as the ICE microcomputer, and the security can be improved.

According to still another aspect of the invention, a program developing system includes an information security microcomputer having an information security function, a main body controlling the information security microcomputer to assist program development, and a computer issuing a command to the information security microcomputer via the main body. Authentication is performed between at least two of the information security microcomputer, the main body and the computer.

Since the authentication is performed between at least two of the information security microcomputer, the main body and the computer, the main body or the computer, which is not authorized, cannot use the information security microcomputer as the ICE microcomputer, and the security can be improved.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing a schematic structure of an ICE microcomputer in a first embodiment of the invention.

FIG. 2 illustrates authentication between an ICE microcomputer 1 and an ICE main body.

FIG. 3 shows by way of example a program developing system using an ICE microcomputer 1 in the first embodiment of the invention.

FIG. 4 is a block diagram illustrating a functional structure of an ICE 2.

FIGS. 5 to 7 are flowcharts illustrating processing procedures of the program developing systems using ICE microcomputers 1 in the first to third embodiments of the invention, respectively.

FIG. 8 is a block diagram illustrating a functional structure of an ICE main body 21 in a fourth embodiment of the invention.

FIG. 9 is a block diagram showing by way of example a schematic structure of a program developing system in a fifth embodiment of the invention.

FIG. 10 is a block diagram showing another example of a schematic structure of the program developing system in the fifth embodiment of the invention.

FIGS. 11 to 13 are block diagrams showing schematic structures of program developing systems in sixth, seventh and eighth embodiments of the invention, respectively.

FIG. 14 is a flowchart illustrating processing procedures of the program developing system in the eighth embodiment of the invention.

FIG. 15 is a block diagram showing by way of example a program developing system in a tenth embodiment of the invention.

FIGS. 16A and 16B show an example of a structure of an ICE microcomputer switchable between an ICE mode and a general mode.

FIG. 17 shows by way of example a mode-lock circuit for an ICE microcomputer in an eleventh embodiment of the invention.

FIG. 18 shows another example of the mode-lock circuit for the ICE microcomputer in the eleventh embodiment of the invention.

### DESCRIPTION OF THE PREFERRED EMBODIMENTS

(First Embodiment)

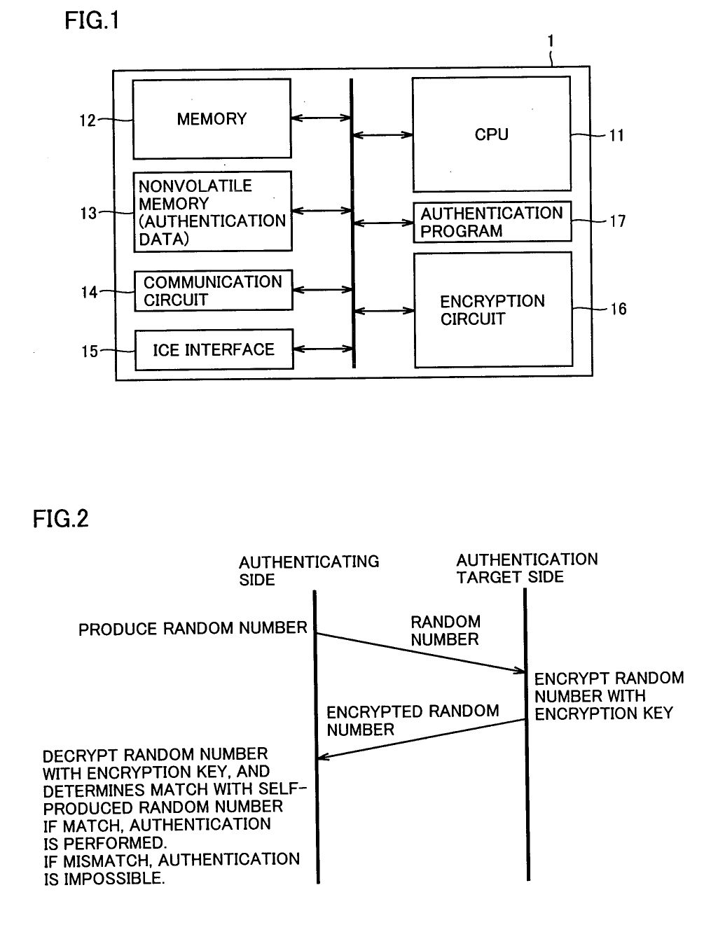

FIG. 1 is a block diagram showing a schematic structure of an ICE microcomputer (i.e., a microcomputer for an ICE) in a first embodiment of the invention. An ICE microcomputer 1 includes a CPU (Central Processing Unit) 11 performing entire control of ICE microcomputer 1, a memory 12 storing a program and data, a nonvolatile memory 13 storing authentication data and others, a communication circuit 14 for communication with an external device, an ICE interface 15 for communication with an ICE main body, an encryption circuit 16 performing encryption and decryption of predetermined data with authentication data, and generating a random number, and an authentication program 17 for performing authentication with respect to the ICE main body.

Encryption circuit 16 is achieved by an operation, in which CPU 11 executes a program of performing encryption and decryption with reference to authentication data stored in nonvolatile memory 13. Authentication of the ICE main body is performed by an operation, in which CPU 11 executes authentication program 17 (i.e., program 17 for authentication). Authentication program 17 may be stored in memory 12.

FIG. 2 illustrates the authentication between ICE microcomputer 1 and the ICE main body. FIG. 2 illustrates, by way of example, authentication, which is of a challenge and response type, and employs a symmetric key encryption method. It is assumed that ICE microcomputer 1 and the ICE main body store, in advance, authentication data forming the same authentication key. Instead of the symmetric key encryption method, a public key encryption method may be used.

CPU 11 in ICE microcomputer 1 (on the authenticating side) executes authentication program 17 to generate a random number, and sends the generated random number to the ICE main body to be authenticated via ICE interface 15.

The ICE main body receives the random number from ICE microcomputer 1, and encrypts this random number with the authentication data already stored. The ICE main body sends the encrypted random number to ICE microcomputer 1.

ICE microcomputer 1 receives the encrypted random number from the ICE main body, and decrypts it with the authentication data stored in advance in nonvolatile memory 13. When the value obtained by the decryption matches with the random number generated by ICE microcomputer 1 itself, it is determined that the ICE main body is authenticated. When the value obtained by the decryption does not match with the random number generated by ICE microcomputer 1 itself, it is determined that the ICE main body cannot be authenticated.

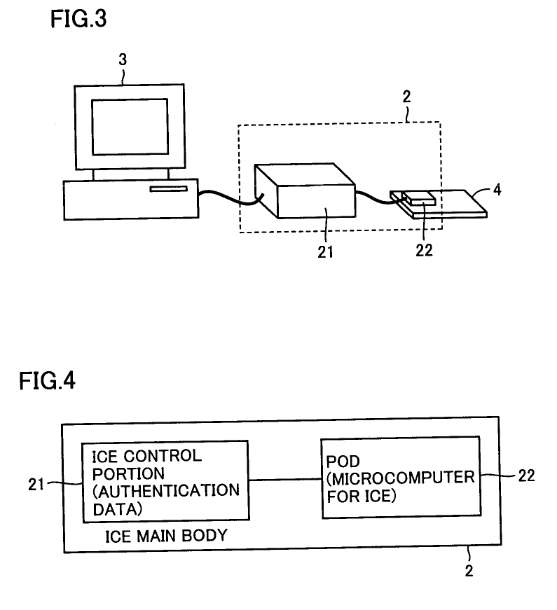

FIG. 3 shows an example of the program developing system using ICE microcomputer 1 in the first embodiment of the invention. The program developing system includes an ICE 2, a personal computer 3 connected to ICE 2, and a target board 4. ICE 2 includes an ICE main body 21 and a POD 22 carrying ICE microcomputer 1. POD 22 is connected to target board 4.

Personal computer 3 sends instructions to ICE 2, and thereby achieves functions of, e.g., executing the program relating to ICE microcomputer 1, dumping of contents of the memory mounted on target board 4, executing steps of the program on the instruction-by-instruction basis, and breaking or stopping the program at a predetermined address.

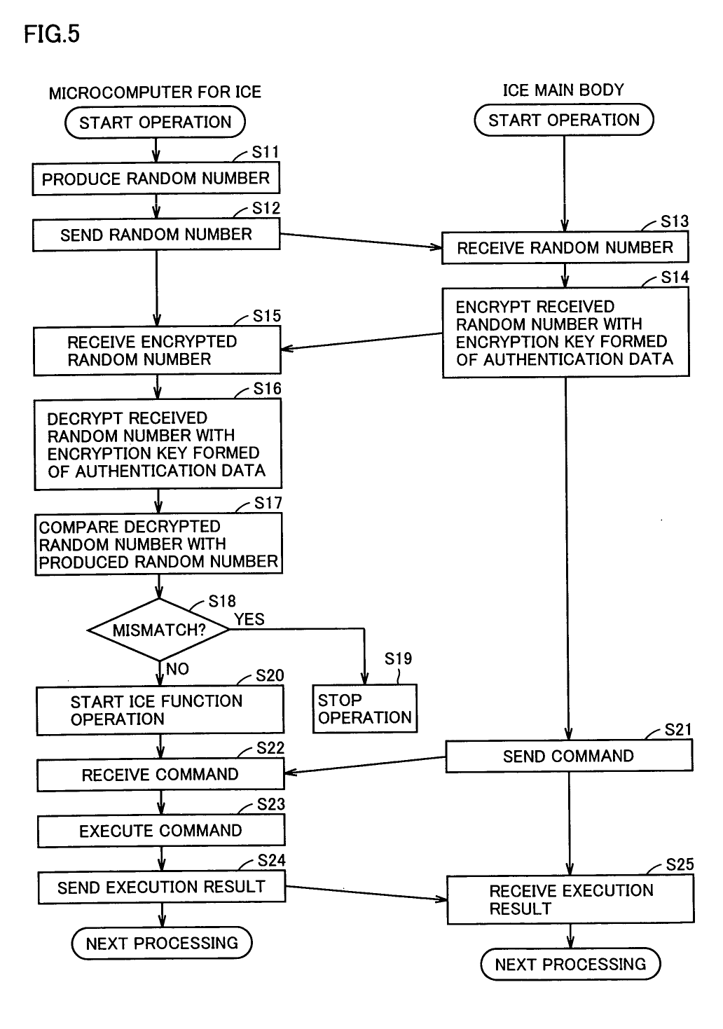

FIG. 4 is a block diagram illustrating a functional structure of ICE 2. ICE 2 includes an ICE control portion (ICE main body) 21 performing entire control of ICE 2, and POD 22 carrying ICE microcomputer 1.

ICE control portion 21 holds in advance the authentication data. When ICE control portion 21 receives the random number from ICE microcomputer 1, it encrypts the random number with the authentication data, and sends it to ICE microcomputer 1. When ICE control portion 21 receives an instruction from personal computer 3, it sends the instruction to ICE microcomputer 1 mounted on POD 22.

FIG. 5 is a flowchart illustrating processing procedures of the program developing system using ICE microcomputer 1 in the first embodiment of the invention. When ICE microcomputer 1 mounted on POD 22 starts the operation, CPU 11 generates a random number (S l), and sends the random number to ICE main body 21 via ICE interface 15 (S12).

When ICE main body 21 receives a random number from ICE microcomputer 1 (S13), it encrypts the received random number with an encryption key formed of the authentication data, which is held in advance. ICE main body 21 sends the encrypted random number to ICE microcomputer 1 (S14).

When ICE microcomputer 1 receives the encrypted random number from ICE main body 21 (S15), it decrypts the encrypted random number thus received with a decryption key formed of the authentication data, which is held in advance in nonvolatile memory 13 (S 16). ICE microcomputer 1 compares the decrypted value with the random number produced by it (S 17).

When the decrypted value does not match with the random number produced by ICE microcomputer 1 (YES in step S18), it stops the entire operation of ICE microcomputer 1 (S 19). When the decrypted value matches with the random number produced by ICE microcomputer 1 (NO in step S18), the ICE function starts to operate (S20).

When ICE main body 21 sends a command to ICE microcomputer 1 (S21), ICE microcomputer 1 receives the command (S22), and executes the received command (S23). ICE microcomputer 1 sends a result of execution of the command to ICE main body 21 (S24). When ICE main body 21 receives the result of execution of the command from ICE microcomputer 1 (S25), it sends the result of execution to personal computer 3, and waits for reception of a next instruction from personal computer 3.

In the foregoing description, ICE microcomputer 1 authenticates ICE main body 21. However, ICE main body 21 may be configured to authenticate ICE microcomputer 1. Thereby, both of them can be authenticated so that the security can be further improved.

According to ICE microcomputer 1 in the first embodiment, as described above, authentication of ICE main body 21 is attempted. If the authentication is performed, ICE microcomputer 1 performs the ICE function. If the authentication cannot be performed, ICE microcomputer 1 stops the operation. Therefore, a malicious person cannot use the ICE microcomputer in another system so that the security can be improved.

(Second Embodiment)

In ICE microcomputer 1 according to the first embodiment of the invention, ICE microcomputer 1 stops its entire operation when the authentication cannot be performed. According to a second embodiment, however, ICE microcomputer 1 stops only an operation of encryption circuit 16 within ICE microcomputer 1 when the authentication cannot be performed.

ICE microcomputer in the second embodiment of the invention differs from the ICE microcomputer in the first embodiment shown in FIG. 1 only in that only the operation of encryption circuit 16 is stopped when the authentication of ICE main body 21 cannot be performed. Therefore, description of the same or corresponding structures and functions is not repeated.

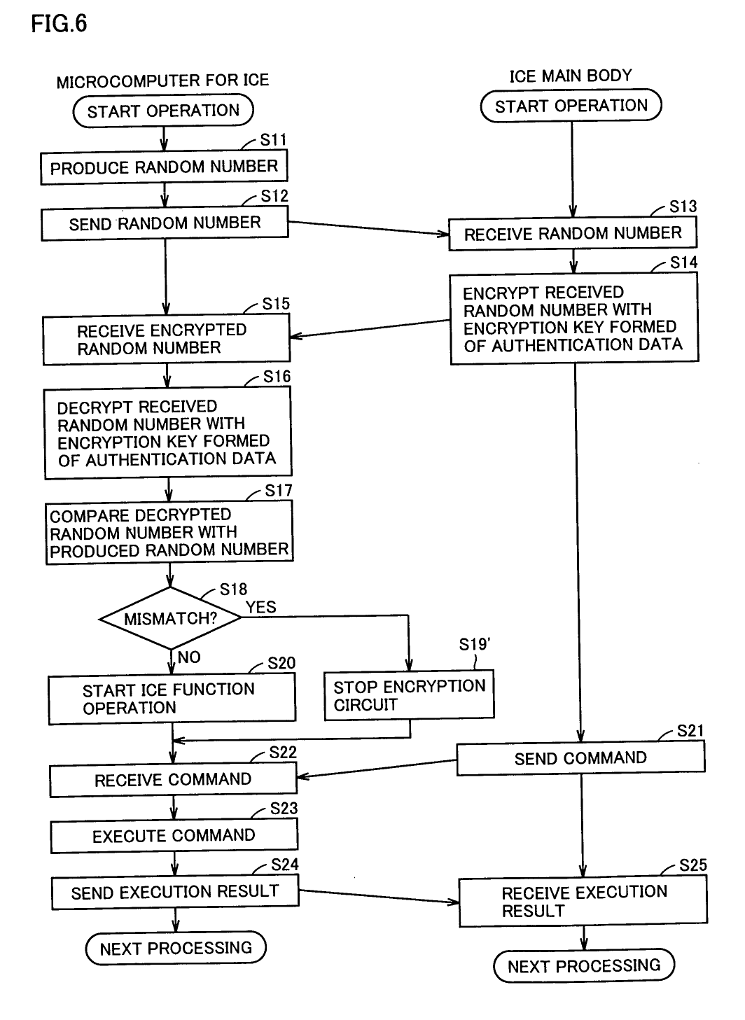

FIG. 6 is a flowchart illustrating processing procedures of the program developing system using ICE microcomputer 1 according to the second embodiment of the invention. As compared with the processing procedures of the program developing system in the first embodiment illustrated in FIG. 5, the procedures in FIG. 6 differ only in processing performed in a step S19. Therefore, description of the same or corresponding processing procedures is not repeated. In the second embodiment, a reference number “S19″” is assigned to a step corresponding to step S19 in the first embodiment.

When the decrypted value does not match with the self-produced random number in step S18 (YES in step S18), ICE microcomputer 1 stops only the operation of encryption circuit 16 (S19′). When the decrypted value matches with the self-produced random number (NO in step S18), the operation of the ICE function starts (S20).

In general, debugging relating to the security is concentratedly performed on the program using encryption circuit 16. Therefore, the system may be configured to allow the use of encryption circuit 16 by a person debugging the program relating to the security and to inhibit the use of encryption circuit 16 by other persons. For example, ICE 2 may be required to authenticate the user upon start-up of the personal computer, and ICE main body may perform the authentication with respect to ICE microcomputer 1. When the authentication is performed, the entire operation of ICE microcomputer 1 including encryption circuit 16 is allowed. When the authentication cannot be performed, only the operation of encryption circuit 16 is inhibited, and the other operations are allowed.

According to ICE microcomputer 1 of the second embodiment, as described above, the authentication of ICE main body 21 is attempted, and the operation of the ICE function is performed when the authentication is performed. When the authentication cannot be performed, only the operation of encryption circuit 16 in ICE microcomputer 1 is stopped. Therefore, only an authorized developer can perform debugging with encryption circuit 16, and an unauthorized developer can perform only the debugging not using encryption circuit 16. In this manner, program developing can be performed in a role-shared manner.

(Third Embodiment)

ICE microcomputer 1 in the first embodiment of the invention is configured to stop the entire operation of ICE microcomputer 1 when the authentication cannot be performed. According to a third embodiment, however, ICE microcomputer 1 is configured such that encryption circuit 16 in ICE microcomputer 1 do not provide correct results of operations when the authentication cannot be performed.

ICE microcomputer 1 according to the third embodiment of the invention differs from the ICE microcomputer in the first embodiment shown in FIG. 1 only in that encryption circuit 16 does not provide correct results of operations when ICE main body 21 cannot be authenticated. Therefore, description of the same or corresponding structures and functions is not repeated.

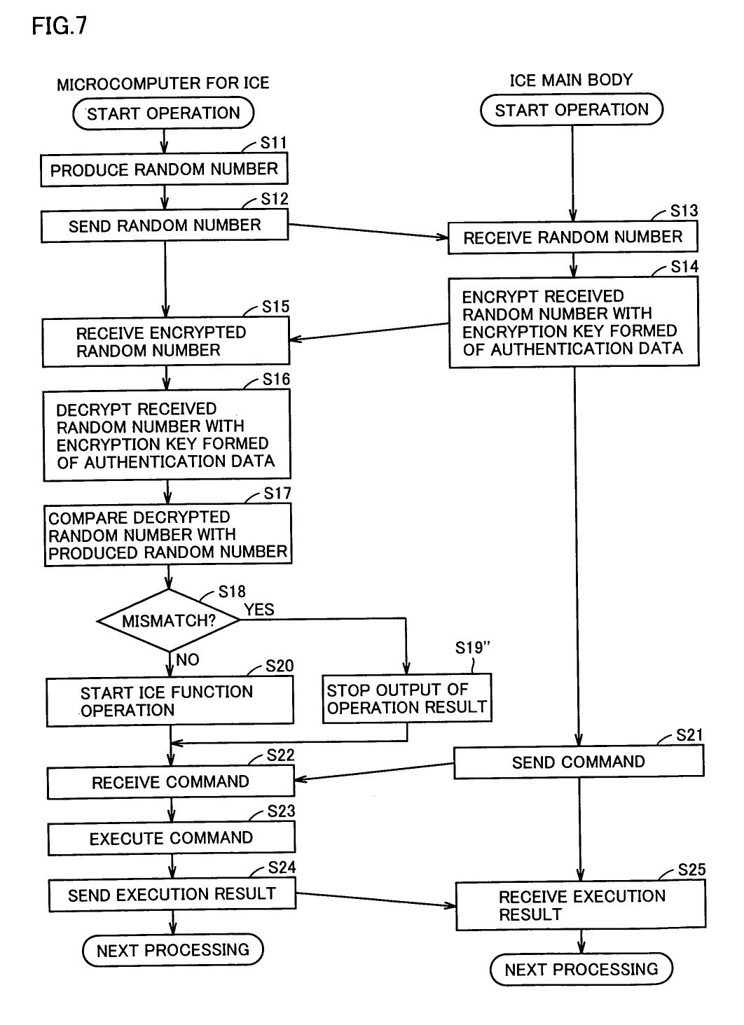

FIG. 7 is a flowchart illustrating processing procedures of the program developing system using ICE microcomputer 1 in the third embodiment of the invention. The procedures in FIG. 5 differ from the processing procedures of the program developing system in the first embodiment illustrated in FIG. 1 only in the processing performed in step S19. Therefore, specific description will not be given on the same or corresponding processing procedures. In this embodiment, a reference number “19″”is assigned to a step corresponding to step S19 in the first embodiment.

When the decrypted value does not match with the self-produced random number in step S18 (YES in step S18), encryption circuit 16 in ICE microcomputer 1 does not provide correct results of the operation or arithmetic (S19″). When the decrypted value matches with the self-produced random number (NO in step S18), the operation of the ICE function starts (S20). The processing may be configured such that any result of the operation is not provided when the decrypted value does not match with the self-produced random number.

In general, the debugging relating to the security is concentratedly performed on the program using encryption circuit 16. Therefore, system may be configured such that only a person performing the debugging of the program relating to the security is authorized to use encryption circuit 16, and the others are allowed to use encryption circuit 16 but cannot determine the security information. For example, ICE 2 may be required to authenticate the user upon start-up of the personal computer, and ICE main body 21 may perform the authentication with respect to ICE microcomputer 1. When the authentication is performed, the entire operation of ICE microcomputer 1 including encryption circuit 16 is allowed. When the authentication cannot be performed, encryption circuit 16 operates not to provide correct results of the operation, but the other operations of ICE microcomputer 1 are allowed.

According to ICE microcomputer 1 in the third embodiment, as described above, authentication of ICE main body 21 is attempted, and the operation of the ICE function is performed when the authentication is performed. When the authentication cannot be performed, encryption circuit 16 in ICE microcomputer 1 does not provide correct results of the operation. Therefore, only an authorized developer can perform debugging with encryption circuit 16, and an unauthorized developer can perform only functional verification of encryption circuit 16, but cannot determine the security information. In this manner, program developing can be performed in a role-shared manner.

(Fourth Embodiment)

According to a fourth embodiment of the invention, a program developing system has a schematic structure similar to that of the program developing system of the first embodiment shown in FIG. 3. Also, ICE 2 in the fourth embodiment of the invention has a functional structure similar to that of ICE 2 in the first embodiment. Therefore, description of the same or corresponding structures and functions is not repeated.

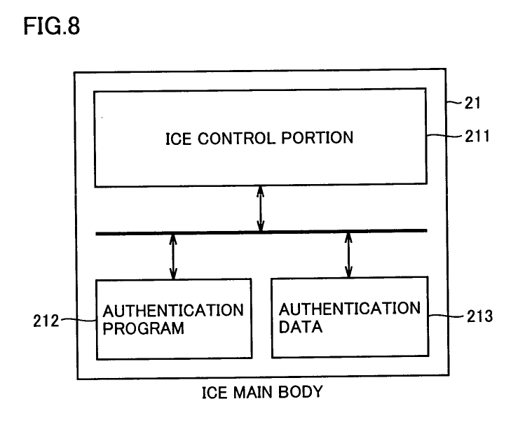

FIG. 8 is a block diagram illustrating a functional structure of ICE main body 21 in the fourth embodiment of the invention. ICE main body 21 includes an ICE control portion 211 performing entire control of ICE main body 21, an authentication program 212 (i.e., program for authentication) and authentication data 213.

ICE control portion 211 has a host interface for communication with personal computer 3, and an ICE interface for communication with ICE microcomputer 1. When ICE control portion 211 receives a command from personal computer 3 via the host interface, it sends the received command to ICE microcomputer 1. When ICE control portion 211 receives a result of execution of the command from ICE microcomputer 1, it sends the result of execution to personal computer 3. In this manner, personal computer 3 can control the operation of ICE microcomputer 1.

ICE main body 21 has authentication data 21, which is the same as the authentication data stored in ICE microcomputer 1, and authentication program 212 performs authentication similar to that of ICE microcomputer 1 with authentication data 213. When ICE microcomputer 1 cannot be authenticated, ICE microcomputer 1 operates similarly to ICE microcomputers 1 in the first to third embodiments already described with reference to FIGS. 5 to 7.

According to the program developing system, as described above, ICE main body 21 is configured to authenticate ICE microcomputer 1. Therefore, ICE main body 21 not having an authentication function cannot perform debugging and others with ICE microcomputer 1 so that the security can be improved.

(Fifth Embodiment)

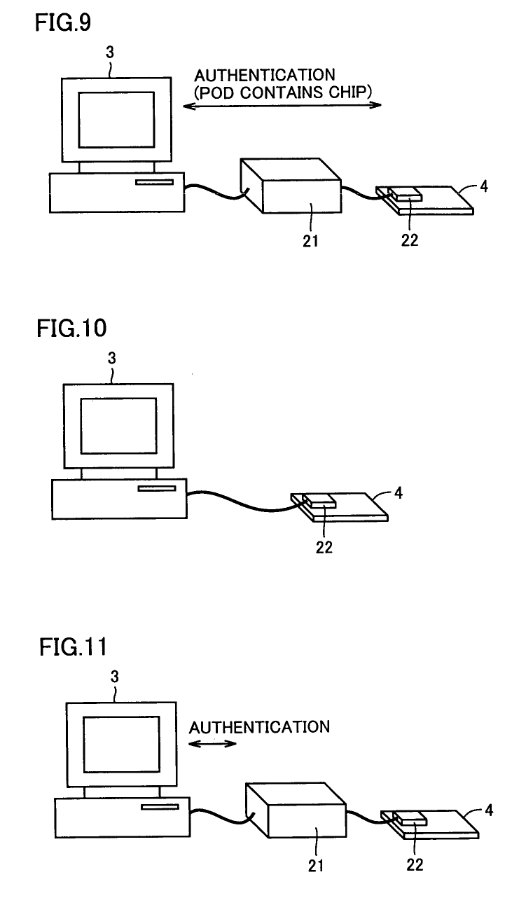

FIG. 9 is a block diagram showing an example of a schematic structure of the program developing system in the fifth embodiment of the invention. The program developing system includes personal computer 3, ICE main body 21, POD 22 and target board 4. Personal computer 3 stores the authentication program and the authentication data, and ICE microcomputer 1 operates to authenticate personal computer 3. When personal computer 3 cannot be authenticated, ICE microcomputer 1 operates similarly to ICE microcomputers 1 in the first to third embodiments already described with reference to FIGS. 5 to 7.

FIG. 10 is a block diagram illustrating another example of the schematic structure of the program developing system in the fifth embodiment of the invention. The program developing system includes personal computer 3, POD 22 and target board 4. Personal computer 3 includes the same function as that of ICE main body 21, and personal computer 3 performs the communication directly with ICE microcomputer 1 in POD 22 so that ICE microcomputer 1 can authenticate personal computer 3.

In the foregoing description, ICE microcomputer 1 authenticates personal computer 3. However, personal computer 3 may be configured to authenticate ICE microcomputer 1. Thereby, both of them can be authenticated so that the security can be further improved.

According to the program developing system in the fifth embodiment, as described above, authentication is preformed between ICE microcomputer 1 and personal computer 3. Therefore, personal computer 3 not authorized to use ICE microcomputer 1 cannot operate ICE microcomputer 1 so that the security can be improved. Even when a measuring device other than personal computer 3 is connected, authentication cannot not be performed with respect to ICE microcomputer 1 so that ICE microcomputer 1 can be prevented from being analyzed.

(Sixth Embodiment)

FIG. 11 is a block diagram illustrating a schematic structure of the program developing system in a sixth embodiment of the invention. The program developing system includes personal computer 3, ICE main body 21, POD 22 and target board 4. Personal computer 3 stores the authentication program and authentication data. ICE main body 21 likewise stores the authentication program and authentication data, and ICE main body 21 authenticates personal computer 3. When personal computer 3 cannot be authenticated, ICE microcomputer 1 operates similarly to ICE microcomputers 1 in the first to third embodiments already described with reference to FIGS. 5 to 7.

In the foregoing description, ICE main body 21 authenticates personal computer 3. However, personal computer 3 may be configured to authenticate ICE main body 21 so that both of them can be authenticated. Thereby, the security can be further improved.

According to the program developing system in the sixth embodiment, as described above, the authentication is performed between ICE main body 21 and personal computer 3. Therefore, personal computer 3 not authorized to use ICE main body 21 cannot operate ICE microcomputer 1 so that the security can be improved. Even when a measuring device other than personal computer 3 is connected, authentication with respect to ICE main body 21 cannot be performed so that ICE microcomputer 1 is prevented from being analyzed.

(Seventh Embodiment)

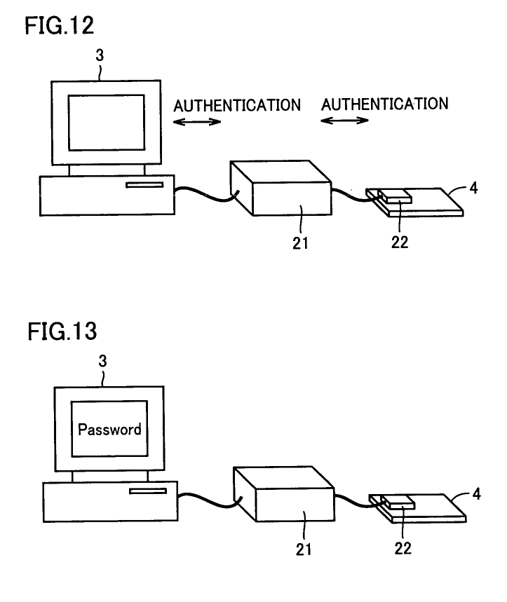

FIG. 12 is a block diagram illustrating an example of a schematic structure of a program developing system in a seventh embodiment of the invention. The program developing system includes personal computer 3, ICE main body 21, POD 22 and target board 4. Personal computer 3 stores the authentication program and authentication data. ICE main body 21 likewise stores the authentication program and authentication data.

Authentication is performed between ICE microcomputer 1 and ICE main body 21, and is also performed between ICE main body 21 and personal computer 3. When the authentication between ICE microcomputer 1 and ICE main body 21 and/or the authentication between ICE main body 21 and personal computer 3 cannot be performed, ICE microcomputer 1 operates similarly to ICE microcomputers 1 in the first to third embodiments already described with reference to FIGS. 5 to 7.

According to the program developing system in this embodiment, as already described, the authentication is performed between ICE microcomputer 1 and ICE main body 21, and between ICE main body 21 and personal computer 3. Therefore, ICE main body 21 or personal computer 3, which is not authorized to use ICE microcomputer 1, cannot operate ICE microcomputer 1. Therefore, the security can be improved.

(Eighth Embodiment)

FIG. 13 is a block diagram illustrating by way of example a schematic structure of a program developing system according to an eighth embodiment of the invention. This program developing system includes personal computer 3, ICE main body 21, POD 22 and target board 4. Personal computer 3 receives a password entered by a user, and sends the password to ICE microcomputer 1. ICE microcomputer 1 compares the password received from personal computer 3 with the password stored in advance, and sends a result of the comparison to personal computer 3.

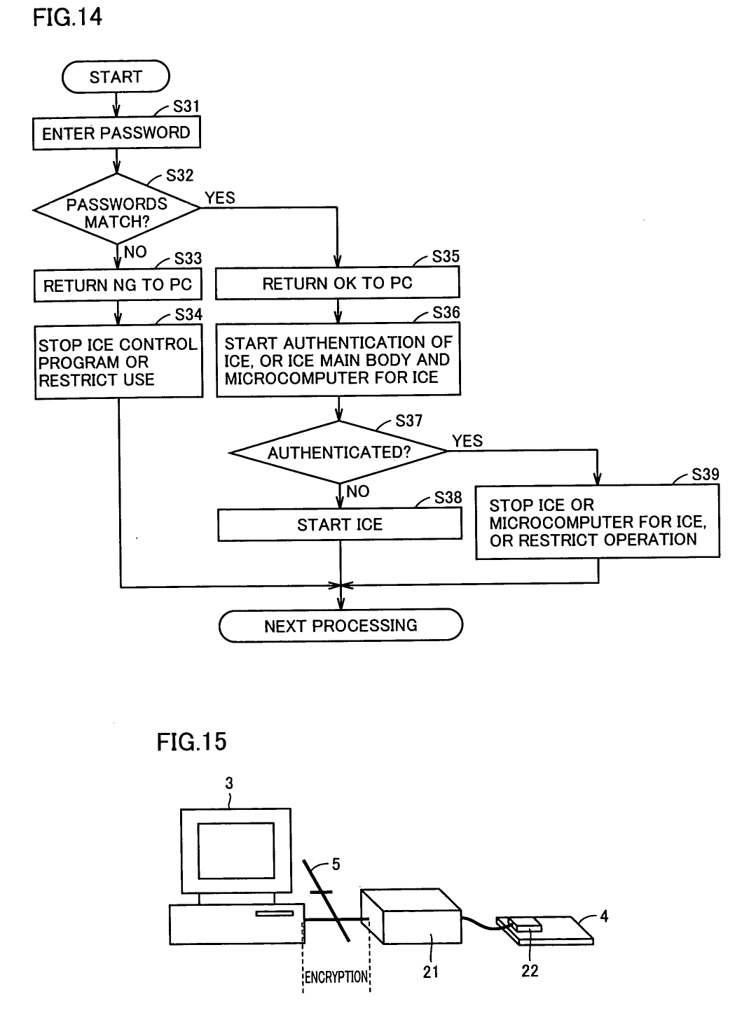

FIG. 14 is a flowchart illustrating processing procedures of a program developing system in the eighth embodiment of the invention. When a user enters a password into personal computer 3 (S31), the password is sent to ICE microcomputer 1 via ICE main body 21.

ICE microcomputer 1 compares the password received from personal computer 3 with the password stored in advance (S32). When these passwords do not match with each other (NO in step S32), ICE microcomputer 1 notifies personal computer 3 of the mismatch between these passwords (S33). When the passwords match with each other (YES in step S32), ICE microcomputer 1 notifies personal computer 3 of the match between the passwords (S35).

When personal computer 3 receives the notification of the mismatch between the passwords from ICE microcomputer 1, personal computer 3 stops the program for controlling ICE 2, or restricts the use of ICE 2 (S34). When personal computer 3 receives the notification of the match between the passwords from ICE microcomputer 1, personal computer 3 starts the operation for authentication between personal computer 3 and ICE main body 21, or instructs to perform the authentication between ICE main body 21 and ICE microcomputer 1 (S36).

If the authentication between personal computer 3 and ICE main body 21, or the authentication between ICE main body 21 and ICE microcomputer 1 is performed (NO in step S37), ICE 2 starts the operation (S38). If the authentication between personal computer 3 and ICE main body 21, or the authentication between ICE main body 21 and ICE microcomputer 1 cannot be performed (YES in step S37), the operation of ICE 2 or ICE microcomputer 1 is stopped or restricted (S39).

Personal computer 3 may be configured to lock a screen if the user do not operate personal computer 3 for a predetermined time. In this case, the screen is unlocked when the user enters the password again. In this manner, it is possible to prevent an unauthorized person from using ICE 2 to perform debugging or analyzing of the program during absence of the authorized person.

By administering the users with the passwords and IDs, appropriate authorities for the use can be given to users in accordance with the shared roles. For example, ICE microcomputer 1 may be configured to select and execute one of the operation restrictions already described in the first to third embodiments in accordance with the ID entered by the user. Thereby, the allowed level of the debugging can be determined for each user in accordance with the ID.

According to the program developing system in this embodiment, as already described, ICE microcomputer 1 compares the password entered via personal computer 3 with the password held in advance, and the operations of ICE microcomputer 1 or ICE 2 are restricted in accordance with the result of the comparison. Therefore, the security can be improved, and the convenience of the user can be improved.

(Ninth Embodiment)

A program developing system according to a ninth embodiment of the invention differs from the program developing systems in the fourth to eighth embodiments only in that the authentication is performed at predetermined time intervals. Therefore, description of the same or corresponding portions is not repeated.

In the program developing system of the fourth embodiment, ICE microcomputer 1 will continue the operation even if ICE main body 21 attached to ICE microcomputer 1 is fraudulently replaced with another device after the authentication was performed between ICE microcomputer 1 and ICE main body 21. Therefore, even an unauthorized person can debug and analyze the program with ICE 2. For preventing this, the authentication of ICE microcomputer 1 and ICE main body 21 is performed at predetermined time intervals.

Signature data may be added to commands and/or responses to be sent or received, whereby fraudulent replacement of the device can be prevented. In this case, the signature data can be produced in such a manner that communication data is compressed, and then is encrypted with authentication data. For compression of the communication data, the Hash function or the like can be used. The communication data can be encrypted without compression.

According to the program developing system of this embodiment, as described above, since the authentication is repeated at predetermined time intervals, fraudulent replacement of the device can be prevented.

(Tenth Embodiment)

FIG. 15 is a block diagram illustrating an example of a schematic structure of a program developing system in a tenth embodiment of the invention. This program developing system includes personal computer 3, ICE main body 21 connected to personal computer 3 via a network 5, POD 22 and target board 4.

For debugging the program with ICE main body 21, it is necessary to download a program from personal computer 3 into ICE main body 21. The program of the information security microcomputer requires a high security level, and may be used, e.g., for forging a system carrying an information security microcomputer if the program to be downloaded into ICE main body 21 leaks externally.

The possibility of interception of the program is low if personal computer 3 and ICE main body 21 are connected in a one-to-one relationship. However, if personal computer 3 and ICE main body 21 are connected over network 5 such as a LAN (Local Area Network), the possibility of interception of the program increases. For preventing this, the communication data is encrypted in this embodiment.

For example, the communication data (program) is encrypted by using the authentication data and the encryption function, which are used for authenticating personal computer 3 and ICE main body 21, and is downloaded into ICE main body 21. ICE main body 21 stores the program in memory 12 after decrypting it with the same authentication data. The authentication data (encryption key) and the authenticating function for the communication may be different from those for the authentication.

According to the program developing system in this embodiment, as described above, since personal computer 3 encrypts the communication data for downloading it into ICE main body 21, it is possible to reduce the possibility of the interception of the communication data over the network.

(Eleventh Embodiment)

ICE microcomputers 1 in the first to third embodiments already described may be used as general information security microcomputers to be incorporated into a system or the like.

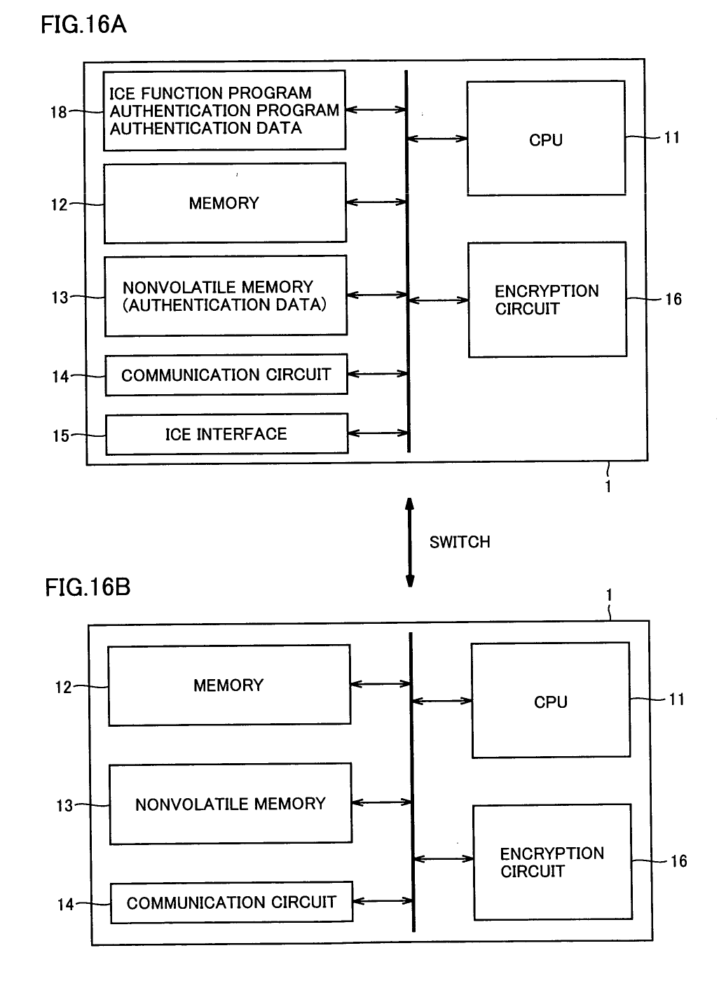

FIGS. 16A and 16B show an example of a structure of an ICE microcomputer, of which operation mode is switchable between an ICE mode (debug mode) and a general mode. As illustrated in FIG. 16A, when ICE microcomputer 1 operates in the ICE mode, control is performed to operate ICE interface 15 and an ICE function program (including authentication program and authentication data) 18. ICE function program 18 is stored in a mask ROM (Read Only Memory), OTPROM (One Try Programmable ROM) or the like.

As shown in FIG. 16B, when ICE microcomputer 1 operates in the normal mode, control is performed to stop the operations of ICE interface 15 and ICE function program 18. FIG. 16A shows a practical structure of the ICE microcomputer, and FIG. 16B shows an imaginary structure, which is set in the general mode.

When ICE microcomputer 1 can be used for both the purposes as described above, the ICE mode and the general mode are prepared and selected in many cases. More specifically, by deleting the program for the operation in the ICE mode, the microcomputer can be used as a general information security microcomputer, and therefore may be abused for forging an information security microcomputer.

In this embodiment, such a structure is employed that the program for operation in the ICE mode cannot deleted, or the ICE mode is fixed to inhibit the general mode so that ICE microcomputer 1 cannot be used as the general security microcomputer.

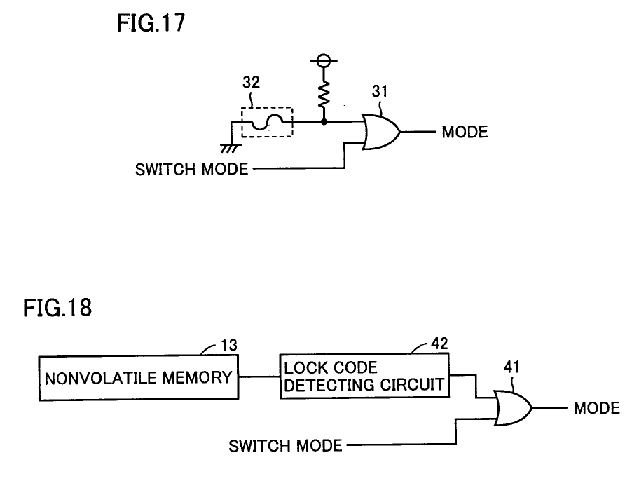

FIG. 17 shows an example of a mode-lock circuit of an ICE microcomputer in an eleventh embodiment of the invention. This mode-lock circuit includes an OR circuit 31 and a fuse 32. For shipping as the general information security microcomputer, fuse 32 is left. Thereby, OR circuit 31 issues a mode select signal as it is. It may be configured to fix the general mode.

For shipping as ICE microcomputer 1, fuse 32 is blown. Thereby, OR circuit 31 outputs a high level regardless of the mode select signal, and the ICE mode is fixed. Thus, ICE microcomputer 1 cannot be used as the general information security microcomputer.

FIG. 18 shows another example of the mode-lock circuit of the ICE microcomputer in this embodiment. The mode-lock circuit includes an OR circuit 41 and a lock code detecting circuit 42. Lock code detecting circuit 42 reads data from a predetermined address in nonvolatile memory 13, and outputs a high level when the read data matches with the lock code. When the read data does not match with the lock code, it outputs a low level.

For shipping as the general information security microcomputer, data other than the lock code is written at predetermined addresses in nonvolatile memory 13. Thereby, OR circuit 41 outputs the mode select signal as it is. It may be configured to fix the general mode.

For shipping as ICE microcomputer 1, the lock code is written at the predetermined address in nonvolatile memory 13. Thereby, OR circuit 41 outputs a high level regardless of the mode select signal, and the ICE mode is fixed. Thus, ICE microcomputer 1 cannot be used as the general information security microcomputer.

According to ICE microcomputer 1 in this embodiment, as described above, since the mode-lock circuit can fix the mode at the ICE mode, ICE microcomputer 1 cannot be used as the general information security microcomputer, and it is possible to reduce the possibility that ICE microcomputer 1 is used for forging the information security microcomputer.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An information security microcomputer having an information security function comprising:
an encrypting unit encrypting and decrypting information;
an authenticating unit authenticating an external device; and
a processor performing entire control of said information security microcomputer, and stopping at least a part of a function of said information security microcomputer when said authenticating unit cannot perform the authentication.

2. The information security microcomputer according to claim 1, wherein
said processor issues a random number to said external device, decrypts information received from said external device, and attempts to authenticate said external device by determining whether the decrypted value matches with said random number or not.

3. The information security microcomputer according to claim 1, wherein
said processor stops an entire operation of said information security microcomputer when said authenticating unit cannot perform the authentication.

4. The information security microcomputer according to claim 1, wherein
said processor stops an operation of said encrypting unit when said authenticating unit cannot perform the authentication.

5. The information security microcomputer according to claim 1, wherein
said processor operates not to output a correct result of an operation of said encrypting unit when said authenticating unit cannot perform the authentication.

6. The information security microcomputer according to claim 1, wherein
said processor operates in either a debug mode or a general mode, and
said information security microcomputer further includes a mode-lock circuit locking the mode at debug mode.

7. A program developing device comprising:
an information security microcomputer having an information security function, and a main body controlling said information security microcomputer to assist program development, wherein
said main body includes a control unit performing authentication with respect to said information security microcomputer, and issuing a command to control said information security microcomputer; and
said information security microcomputer includes:
an authenticating unit performing authentication with respect to said main body, and
a processor performing entire control of said information security microcomputer, and stopping at least a part of a function of said information security microcomputer.

8. A program developing system comprising:
an information security microcomputer having an information security function;
a main body controlling said information security microcomputer to assist program development; and
a computer issuing a command to said information security microcomputer via said main body, wherein
authentication is performed between at least two of said information security microcomputer, said main body and said computer.

9. The program developing system according to claim 8, wherein
said information security microcomputer includes:
an encrypting unit encrypting and decrypting information;
an authenticating unit authenticating said main body or said computer; and
a processor performing entire control of said information security microcomputer, and stopping at least a part of a function of said information security microcomputer when said authenticating unit cannot perform the authentication.

10. The program developing system according to claim 8, wherein
the authentication performed between at least two of said information security microcomputer, said main body and said computer is repeated at predetermined intervals.

11. The program developing system according to claim 8, wherein
said main body performs authentication with respect to said computer, and control is performed to stop an operation of at least a part of a function of said main body when the authentication cannot be performed.

12. The program developing system according to claim 8, wherein
said main body performs authentication with respect to said computer and authentication with respect to said information security microcomputer, and control is performed to stop an operation of at least a part of a function of said information security microcomputer or said main body when the authentication cannot be performed.

13. The program developing system according to claim 8, wherein
said computer receives authentication information from a user, and sends the authentication information to said information security microcomputer,
said information security microcomputer determines whether the authentication information received from said computer matches with authentication information held in advance by said information security microcomputer or not, and
said computer performs control not to operate at least a part of a function of said main body when said information security microcomputer determines mismatch of said authentication information.

14. The program developing system according to claim 13, wherein
said computer requests a user to reenter the authentication information if input by the user is not performed for a predetermined time or more.

15. The program developing system according to claim 8, further comprising:
a network connecting said computer to said main body, wherein
said computer sends a program after encrypting said program when
said program is to be downloaded into said main body, and
said main body executes said encrypted program received from said computer after decrypting said encrypted program.
